(19) United States
(12) Patent Application Publication
(10) Pub. No.: US 2007/0027885 A1
(43) Pub. Date: Feb. 1, 2007

(54) Client server system and method of managing the system capable of quickly giving necessary information to client computer

(75) Inventor: Koichiro Oshida, Kahoku (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/248,186

(22) Filed: Oct. 13, 2005

(30) Foreign Application Priority Data
Jul. 29, 2005 (JP) 2005-221958

(51) Int. Cl. G06F 7/00

(52) U.S. Cl. 707/100

(57) ABSTRACT

A client server system has a network, a server computer that is connected to the network and provides a network service, and a client computer that uses resources of the server computer via the network service. The server computer manages identification information of the client computer that uses the sources provided by the network service, a type of a program that operates in the client computer using the resources, and a type of a user of the program of the client computer. When the network service cannot be provided due to an occurrence of a predetermined problem in the resources of the server computer, the server computer notifies the client computer about information of the network service based on the resources provided by the network service.

### CROSS REFERENCE TO RELATED APPLICATION

This application is based upon and claims the benefit of priority from the prior Japanese Patent Application No. 2005-221958, filed on Jul. 29, 2005, the entire contents of which are incorporated herein by reference.

### BACKGROUND OF THE INVENTION

1. Field of the Invention

The present invention relates to a client server system, a method of managing the system, and a management program of the system. More particularly, the present invention relates to a client server system in which a client computer uses resources within a server computer via a network.

2. Description of the Related Art

Conventionally, in a client server system, a client computer uses resources of a server computer via a network so that a user of the client computer finally uses the resources. Resources of the server computer that the client computer uses via the network are mainly hard disks such as redundant arrays of independent (inexpensive) disks (RAID). The resources also include various kinds of sensors that are connected via input and output devices, and data units that are supplied via the input and output devices.

The server computer includes resources used for a network service, other hardware that constitutes a computer such as a central processing unit (CPU) and a memory, a network connection interface (i.e., a network card), and a cable that is connected to the network. The network service (i.e., a program) that operates in the server computer uses the resources via an operating system (OS).

When an application program of the client computer cannot use any one of a network connection interface, a cable, a network, resources, and other hardware, the application program of the client computer cannot use the resources. In this case, in order to avoid generating confusion in the user, it is desirable that the application program of the client computer notifies the user, as soon as possible, about a fact that the program cannot operate normally because of the occurrence of a problem. However, according to the conventional client server system, notification to the user about a fact that the application program cannot operate normally is delayed, or this cannot be properly notified to the user.

Conventionally, there is proposed a computer system in which the application program of the client computer immediately detects a halting of the server computer and can promptly take a next measure, as described in Japanese Unexamined Patent Publication (Kokai) No. 11-219327 (JPP'327). According to JPP'327, the computer system comprises a unit that always supplies power to a network interface adaptor (NIA), or a network card; a unit that detects whether the server computer on which the self is mounted is suspended; and a unit that generates a distribution inability notification to be transmitted to the client computer. When the server computer is halted, upon reception of a packet to the NIA from the network, the server computer immediately returns the distribution inability notification “the server computer is suspended” to the client computer.

The following technique is also proposed in Japanese Unexamined Patent Publication (Kokai) No. 2000-092054. In the client server network system, each server computer executes a primary notification to a management terminal unit on the network when a trouble occurs. The management terminal unit individually notifies client computers listed up in advance. With this arrangement, by only applying a minor change to the existing network system, the server computer having a trouble can instantly and securely notify the client computer about the occurrence of the trouble.

Further, the following technique is also proposed in Japanese Unexamined Patent Publication (Kokai) No. 2002-259338 (JPP'338). When a proxy server does not receive a response from a web server under its control, a system and a program are arranged to notify a web client about the fact of a stop of the web server, a reason for the stop, and a scheduled time of restarting, in place of a conventional error return.

According to JPP'338, the proxy server comprises a Hyper Text Transport Protocol (HTTP) analyzing unit that decides a web server having information requested in request information from a web client; a web server transmitting unit that transmits the request information; a reply information receiving unit that receives reply information; a client transmitting unit that transmits the reply information to a requester; a reply monitoring unit that detects a reply timeout; and a stop information fetching and transmitting unit. The stop information fetching and transmitting unit fetches stop information containing a stop period of each web server and a recovery schedule, and stop information of a web server corresponding to a timeout. When a web server is suspended, the stop information fetching and transmitting unit instructs the client transmitting unit to transmit a page of stop information containing the stop of the web server, a reason for the stop, a scheduled restarting time, to the requester.

The prior art and its associated problems will be described later with reference to the accompanying drawings.

### SUMMARY OF THE INVENTION

An object of the present invention is to provide a client server system capable of quickly giving necessary information to a client computer when a certain problem occurs in resources of a server computer and when the server computer cannot provide a network service.

According to the present invention, there is provided a client server system comprising a network; a server computer that is connected to the network and provides a network service; and a client computer that uses resources of the server computer via the network service, wherein the server computer manages identification information of the client computer that uses the sources provided by the network service, a type of a program that operates in the client computer using the resources, and a type of a user of the program of the client computer; and when the network service cannot be provided due to an occurrence of a predetermined problem in the resources of the server computer, the server computer notifies the client computer about information of the network service based on the resources provided by the network service.

The server computer may notify the client computer about whether the resources provided by the network service can be normally used at present, and when the resources cannot be normally used, the server computer may notify the client computer about a cause of the inability of using the resources, an estimate time taken until when the resources can be used normally, and a state that the network service cannot be provided.

When the server computer receives a request for a permission of using the network service from the client computer while the network service cannot be provided, the server computer may reply to the client computer that the network service cannot be used in response to the request from the client computer. The server computer may have a clustered configuration; and when one of nodes of the server computer cannot provide a network service, another node of the server computer that takes over the network service notifies the client computer that that the network service cannot be used.

The server computer may have one or a plurality of the resources, and provide one or a plurality of the client computers with the network service. Users of the client computer may be classified into managers who have a special right of managing the installment of a program and starting and stopping the client computer, and general users who have a right of using only a special program. Programs that operate within the client computer which uses the network service of the server computer may be classified into a program that a general user of the client computer can directly start and stop, and a program that only a manager can start and stop and that provides the network service to the program that the general user uses.

According to the present invention, there is also provided a method of managing a client server system in which a server computer is connected to a network and provides a network service, and a client computer uses resources of the server computer via the network service, wherein the server computer manages identification information of the client computer that uses the resources provided by the network service, a type of a program that operates in the client computer using the resources, and a type of a user of the program of the client computer; and when one of nodes of the server computer cannot provide a network service, another node of the server computer that takes over the network service may notify the client computer that the network service cannot be used.

Further, according to the present invention, there is provided a management program of a client server system in which a server computer is connected to a network and provides a network service, and a client computer uses resources of the server computer via the network service, wherein the management program makes the server computer manage identification information of the client computer that uses the resources provided by the network service, a type of a program that operates in the client computer using the resources, and a type of a user of the program of the client computer; and when the network service cannot be provided due to an occurrence of a predetermined problem in the resources of the server computer, the management program makes the server computer notify the client computer about information of the network service based on the resources provided by the network service.

According to the client server system of the present invention, the system monitors which client computers are using which resources and how the client computers are using these resources within the server computer that are used for the network service. When resources within the server computer cannot be used for the network service, the system notifies individual client computers that are using the resources about their using methods, reasons for not being able to use the resources, and recovery schedules.

### BRIEF DESCRIPTION OF THE DRAWINGS

The present invention will be more clearly understood from the description of the preferred embodiments as set forth below with reference to the accompanying drawings, wherein:

FIG. 1 is a block diagram of an example of a simplified configuration of a client server system to which the present invention is applied;

FIG. 2 is a block diagram showing roles of hardware and software of the client server system shown in FIG. 1;

FIG. 3 is a block diagram of a configuration of the client server system shown in FIG. 2 where the system has plural client computers;

FIG. 4 is an explanatory diagram of an example of a processing carried out by the server computer and a processing carried out by the client computer;

FIG. 5 is an explanatory diagram of another example of a processing carried out by the server computer and a processing carried out by the client computer;

FIG. 6 is a block diagram schematically showing one example of a client server system according to the present invention; and

FIG. 7 is a block diagram schematically showing another example of a client server system according to the present invention.

### DESCRIPTION OF THE PREFERRED EMBODIMENTS

Before describing in detail the preferred embodiments of a client server system and a method of managing the system according to the present invention, conventional client server systems and their associated problems will be described with reference to the drawings.

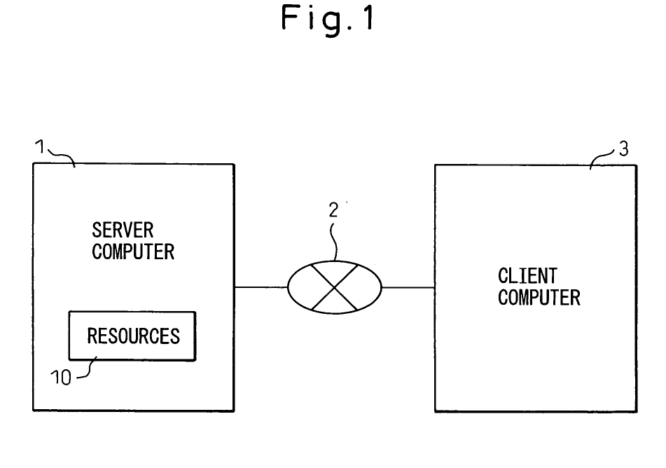

FIG. 1 is a block diagram of an example of a simplified configuration of a client server system to which the present invention is applied. FIG. 1 shows a basic configuration of the system in which one client computer uses resources of one server computer. In FIG. 1, a reference numeral 1 denotes a server computer, 2 denotes a network, 3 denotes a client computer, and 10 denotes resources.

As shown in FIG. 1, in the client server system, the client computer 3 uses the resources 10 of the server computer 1 via the network 2. Finally, a user not shown of the client computer 3 uses the resources 10. The resources 10 of the server computer 1 that the client computer 3 uses via the network 2 are mainly hard disks such as redundant arrays of independent (inexpensive) disks (RAID). The resources 10 also include various kinds of sensors that are connected via input and output devices, and data units that are supplied via the input and output devices.

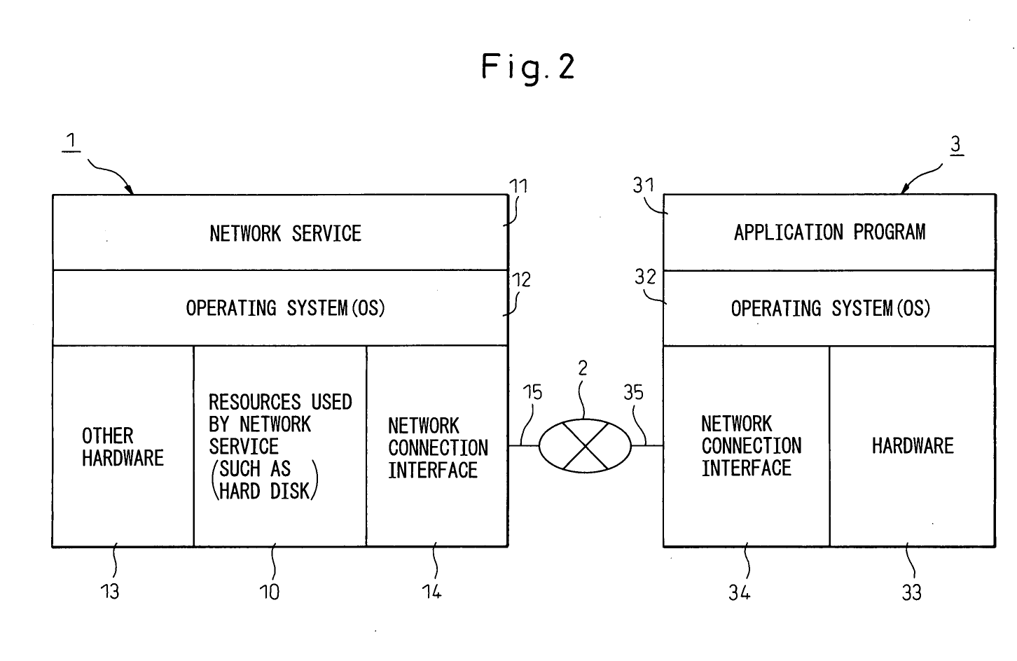

FIG. 2 is a block diagram showing roles of hardware and software of the client server system shown in FIG. 1.

As shown in FIG. 2, the server computer 1 includes the resources 10 used for a network service such as a hard disk, other hardware 13 that constitutes a computer such as a central processing unit (CPU) and a memory, a network connection interface (i.e., a network card) 14, and a cable 15 that is connected to the network 2. A network service (i.e., a program) 11 that operates in the server computer 1 uses the resources 10 via an operating system (OS) 12.

The client computer 3 also includes hardware 33 such as a CPU and a memory, a network connection interface 34, and a cable 35 connected to the network 2, like the server computer 1. Hardware corresponding to the resources 10 of the server computer 1 is not necessary, but can be available.

First, when the client server system is operating normally, an application program (i.e., an application program that uses a network service) 31 that operates in the client computer 3 carries out a calculation using the hardware 33 via the operating system 32, and using the resources 10 when necessary. The application program 31 according to the present invention uses the resources 10 at all times or when necessary. The application program 31 does not operate normally when the program cannot use both the hardware 33 of the client computer 3 and the resources 10 of the server computer 1.

For the application program 31 to use the resources 10, the application program 31 transmits a packet to the network service 11 via the operating system 32, the network connection interface 34, the cable 35, the network 2, the cable 15, the interface 14, and the operating system 12, and communicates with the network service 11, thereby requesting the network service 11 for a permission of using the resources 10.

When the network service 11 receives this request from the application program 31, the network service 11 transmits a packet to the application program 31 through the opposite route via the operating system 12, the interface 14, the cable 15, the network 2, the cable 35, the interface 34, and the operating system 32, and communicates with the application program 31, thereby permitting the application program to use the resources 10.

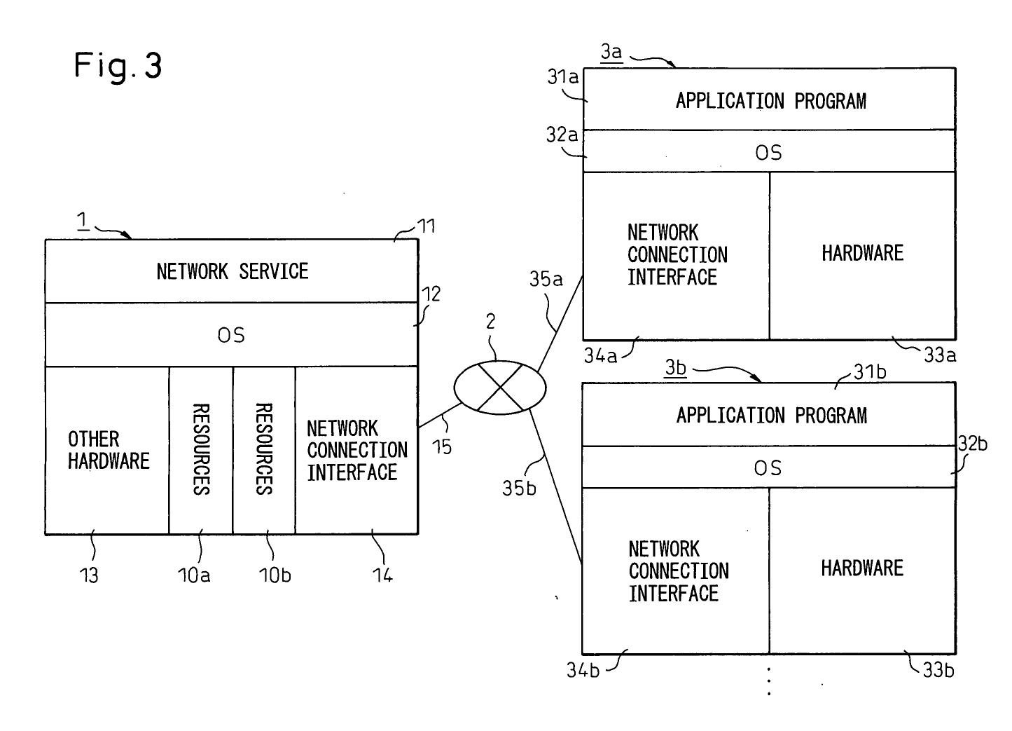

FIG. 3 is a block diagram of a configuration of the client server system shown in FIG. 2 where the system has plural client computers.

As shown in FIG. 3, in the actual client server system, plural client computers 3a, 3b, etc. are connected to one server computer 1. In this example, an application program 31a of the client computer 3a uses resources 10a of the network service via an operating system 32a, an interface 34a, a cable 35a, the network 2, the cable 15, the interface 14, and the operating system 12. An application program 31b of the client computer 3b uses resources 10b of the network service via an operating system 32b, an interface 34b, a cable 35b, the network 2, the cable 15, the interface 14, and the operating system 12.

As explained above, the client computers 3a and 3b do not always use the same resources 10 of the server computer 1, but use mutually different resources 10a and 10b in many cases.

As described above, the application program 31 of the client computer 3 shown in FIG. 2 cannot use the resources 10 when any one of the interface 34, the cable 35, the network 2, the cable 15, the network connection interface 14, the resources 10, and the other hardware 13 cannot be used.

Of course, when the hardware of the client computer 3 in which the application program 31 operates has abnormality, the application program 31 cannot use the resources 10. This problem is not considered in this case.

When any one of the interface 34, the cable 35, the network 2, the cable 15, the network connection interface 14, the resources 10, and the other hardware 13 cannot be used because of a trouble, the application program 31 cannot communicate with the network service 11. Therefore, the user of the client computer 3 using the application program 31 cannot finally use the application program 31.

In this case, in order to avoid confusion of the user, it is desirable that the application program 31 of the client computer 3 notifies the user, as soon as possible, about a fact that the application program cannot operate normally because of the presence of a problem. However, according to the conventional client server system, the application program delays in notifying the user about the fact that the application program cannot operate normally, or cannot notify the user properly about this fact, for the following reasons.

According to the conventional client server system, the client computer 3 has no information of a reason that the client computer 3 cannot use the resources 10. When the application program 31 does not always use the resources 10 but intermittently communicates with the network service 11, the application program cannot understand when the resources 10 have come unable to be used.

The preferred embodiments of a client server system and a method of managing the system according to the present invention will be described in detail below with reference to the accompanying drawings.

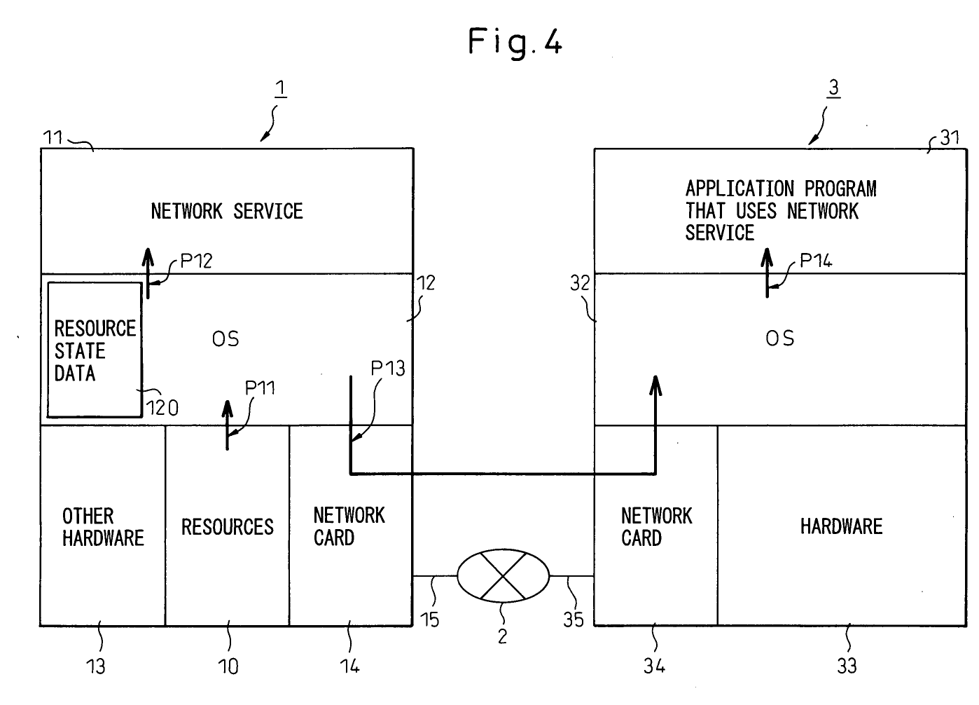

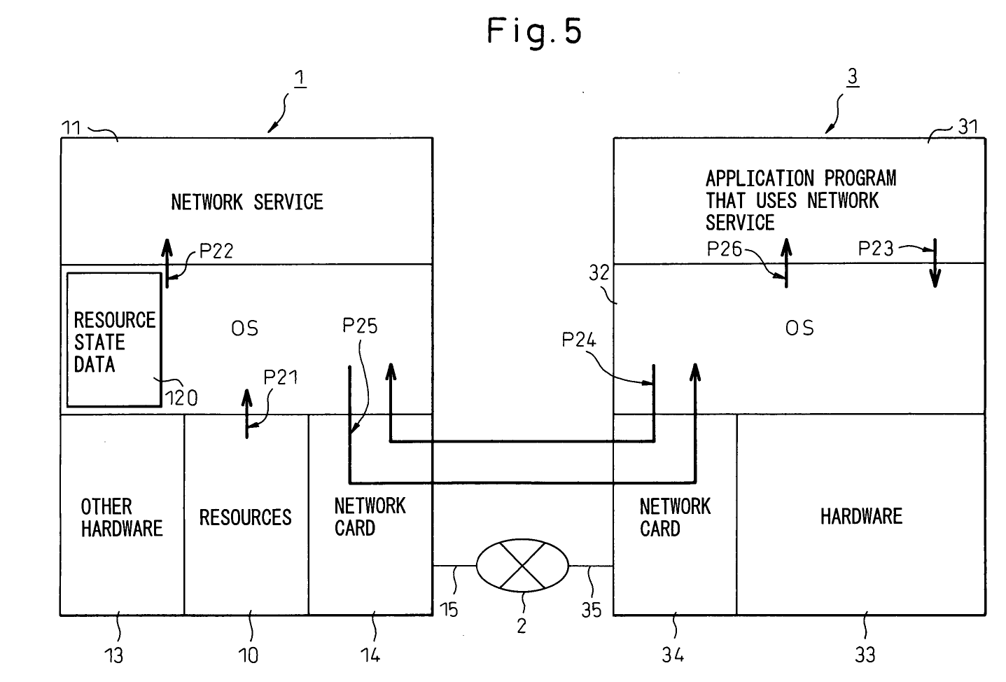

FIG. 4 is an explanatory diagram of an example of a processing carried out by the server computer and a processing carried out by the client computer. FIG. 5 is an explanatory diagram of another example of a processing carried out by the server computer and a processing carried out by the client computer.

In FIGS. 4 and 5, the operating system (OS) 12 or the network service 11 of the server computer 1 monitors a state of the resources 10 and information about the client computer 3 that uses the resources 10. The OS 12 has resource state information 120 of the resources to be notified to the client computer 3 when the network service 11 cannot be used.

The information (i.e., the resource state information 120) held by the server computer 1 includes a state of the resources 10 (for example, a normal state, a state that the resources need to be manually replaced due to a trouble, a state that the resources cannot be used because parts are being replaced and that the resources are automatically recovered soon, and a state that the resources cannot be used because firmware is being updated and that it takes time until the resources are recovered), a state about which client computer (3a, 3b, etc.) is using the resources 10, a type of a user of the application program of the client computer 3 that uses the resources, a state of the other node (when the server computer 1 is a cluster device), etc.

FIG. 4 shows a state that the resources 10 cannot be used and that the server computer 1 autonomously notifies the client computer 3 about this state. In other words, as shown in FIG. 4, when the resources 10 cannot be used and the server computer 1 autonomously notifies the client computer 3 about this state, the server computer 1 operates as follows. First, the OS 12 of the server computer 1 knows that the resources 10 cannot be used due to a trouble in hardware or the like because the resources 10 cannot be accessed normally (P11). Next, the OS 12 of the server computer 1 notifies the network service (i.e., the program) 11 about the state that the resources 10 cannot be used (P12).

The OS 12 of the server computer 1 notifies the OS 32 of the client machine 3 about the fact that the network service 11 cannot be provided, via the network connection interface (i.e., the network card) 14 of the server computer 1, the cable 15, the network 2, the cable 35, and the network card 34 of the client computer 3 (P13).

The OS 32 of the client computer 3 notifies the application program that uses the network service 11 about the fact that the network service 11 of the server computer 1 cannot be used (P14). The OS 12 of the server computer 1 periodically transmits a packet to the client computer 3 indicating that the network service 11 cannot be used, during a period while the network service 11 cannot be provided because of the inability of using the resources 10.

FIG. 5 shows a state that the client computer 3 requests for a permission of using the network service 11 in a state that the resources 10 cannot be used. In other words, as shown in FIG. 5, when the client computer 3 requests for a permission of using the network service 11 in a state that the resources 10 cannot be used, the OS 12 of the server computer 1 knows that data not normal is received from the resources 10 or knows that the resources 10 cannot be used because data is not received from the resources 10 (P21). The OS 12 of the server computer 1 notifies the network service (i.e., the program) about the state that the resources 10 cannot be used (P22).

Next, the application program of the client computer 3 transmits a request for receiving the network service 11, to the OS 32 of the client computer 3 using a system call or an application programming interface (API) (P23).

The OS 32 of the client computer 3 transmits the request for receiving the network service 11 to the OS 12 of the server computer 1 via the network card 34 of the client computer 3, the cable 35, the network 2, the cable 15, and the network card 14 of the server computer 1 (P24).

The OS 12 of the server computer 1 notifies the OS 32 of the client computer 3 about a state that the network service 11 cannot be provided, via the network card 14 of the server computer 1, the cable 15, the network 2, the cable 35, and the network card 34 of the client computer 3 (P25).

The OS 32 of the client computer 3 notifies the application program 31 that uses the network service 11 about the state that the network service 11 of the server computer 1 cannot be used (P26).

The packet that the server computer 1 transmits to the client computer 3 has the following characteristics.

First, the packet is transmitted to only the client computer that uses the resources. The notified packet contains information that the network service cannot be provided at present, information about a reason for not being able to use the resources, such as the hardware is in trouble, the hardware is under maintenance or is busy, and an estimate time taken until the service is recovered.

The content of the packet is changed depending on the type of the application program of the client computer that uses the resources and the type of the user.

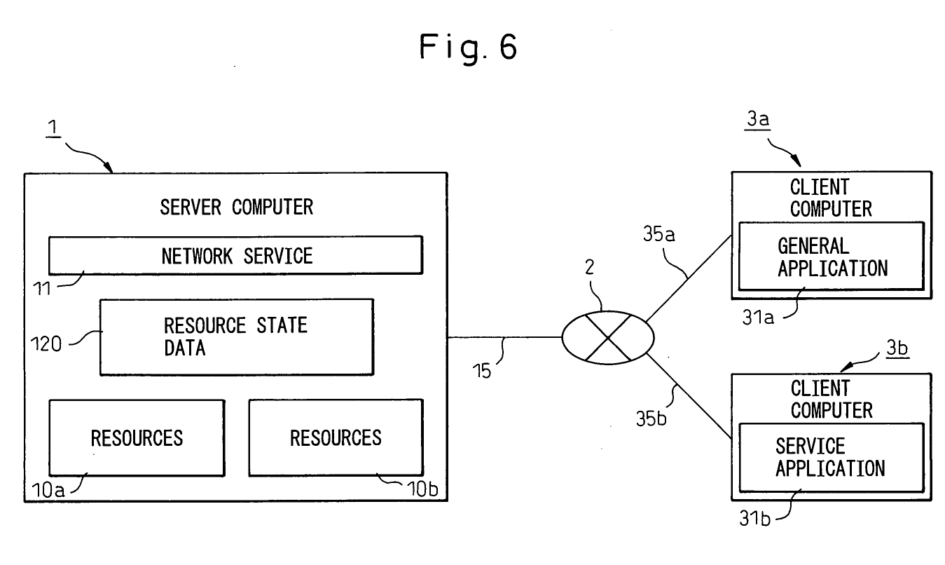

FIG. 6 is a block diagram schematically showing one example of the client server system according to the present invention. In FIG. 6, the server computer 1 has the resources 10a and 10b, and the client computers 3a and 3b are using these resources. In FIG. 6, the application program 31a of the client computer 3a is a general application program such as a word processor, and this application program 31a uses the resources 10a of the server computer 1. The application program 31b of the client computer 3b is a special application program that gives services to other programs such as a web server and a database, and this application program 31b uses the resources 10b of the server computer 1.

The server computer 1 holds the resource state information 120 including the states of the resources 10a and the resources 10b and the information about the application programs on the client computers 3a and 3b that use these resources 10a and 10b.

Consider that a hardware trouble occurs in the resources 10a of the server computer 1 and that the server computer 1 cannot provide the network service 11 to the client computer 3a.

In this case, the server computer 1 transmits a packet to the client computer 3a notifying that the network service 11 cannot be provided. However, because the resources 10b of the server computer 1 can be used, the server computer 1 does not transmit a packet to the client computer 3b.

Because the application program 31a of the client computer 3a that uses the resources 10a is a one used by a general user such as a word processor, the notification content transmitted to the client computer 3a does not include a detailed reason for the occurrence of the hardware trouble in the resources 10a as the reason for not being able to provide the network service 11. Instead, the notification content includes the fact that the network cannot be used at present and an estimate time taken until when the hardware is recovered if the time is known.

When the resources 10b of the server computer 1 cannot be used, the server computer 1 transmits a packet to the client computer 3b notifying that the network service cannot be provided. Because the application program 31b of the client computer 3b that uses the resources 10b of the server computer 1 is a one that gives services to other programs such as a web server, the notification content includes detailed facts that the resources 10b cannot be used, the resources 10b have a hardware trouble, and that the hardware cannot be recovered until when a part is replaced manually.

As explained above, according to the client server system and its management method in the present embodiment, necessary information can be quickly given to the client computer when the network service cannot be provided due to the occurrence of a trouble in the resources of the server computer. The information to be given to the client computer is suitable for the application program of the client computer that uses the resources of the server computer and for the user of the application program. For example, the information is given to avoid generating confusion in the general user of the application program 31a such as a word processor. Also, the information is given to avoid generating a shortage of information for a manager (i.e., a higher-level user) who uses the application program 31b that provides a network service.

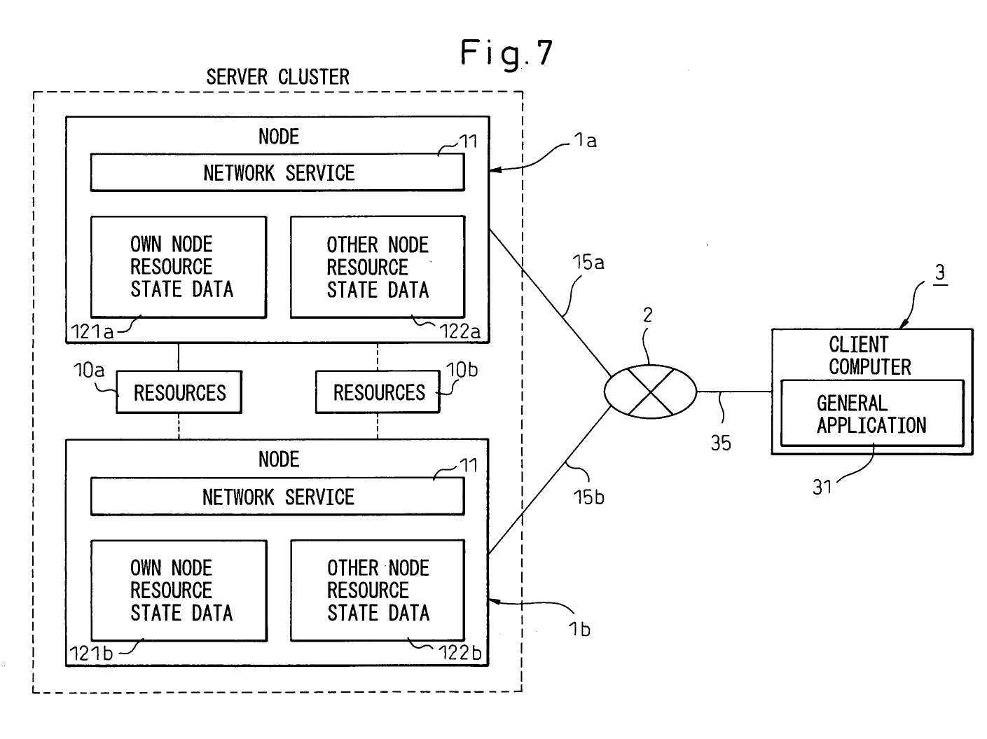

FIG. 7 is a block diagram schematically showing another example of a client server system according to the present invention. In the client server system shown in FIG. 7, the server computer 1 has a clustered configuration. A server computer 1a at a node A side has the resources 10a, and a server computer 1b at a node B side has the resources 10b. Both the server computer 1a and the server computer 1b provide the network service 11. The server computer 1a at the node A side holds state information of the own resources as own node resource state data 121a, and holds state information of the resources of the other server computer 1b at the node B side as other node resource state data 122a. Similarly, the server computer 1b at the node B side holds state information of the own resources as own node resource state data 121b, and holds state information of the resources of the other server computer 1a at the node A side as other node resource state data 122b.

When a trouble occurs in the node A, for example, the server computer 1b at the node B side takes over the resources 10a held by the server computer 1a at the node A side, and continuously provides the network service 11 to the client computer 3 that uses the resources 10a of the server computer 1a. In this way, the server computers are clustered having a redundancy. It is assumed that the client computer 3 uses the resources 10a through the network service of the node A.

When the server computer 1a at the node A side cannot provide the network service 11 to the client computer 3 because of the occurrence of a hardware trouble other than the resources 10a of the node A, the server computer 1b at the node B side takes over the resources 10a, and continuously provides the network service 11 to the client computer 3.

However, when the node A is suddenly in trouble, there is no guarantee that the data held in the resources 10a is correct. Therefore, when the node B takes over the resources 10a from the node A, it is necessary to test whether the data included in the resources 10a has no problem in its consistency. For example, a program of fsck needs to be executed in the case of the UNIX (a registered trade name), and a program of chkdsk needs to be executed in the case of the MS-DOS (a registered trade name). However, when the resources 10a are not a high-speed device such as a memory, and are a device having a mechanical mechanism like a hard disk and having a large amount of data, it takes time to carry out the above test. It takes time for the node B to start providing the network service to the client computer 3. The client computer 3 is kept waited until when the client computer 3 can communicate with the network service of the node A.

In this case, according to the present embodiment, the node B notifies the client computer 3 about the fact that the network service of the node A cannot be provided. Based on this, the client computer 3 can notify the user of the application about the unavailability of the network service. The information packet also includes information that although the node A cannot provide the network service at present, the node B takes over the service and is now under the handover preparation.

The method of managing the client server system according to the present invention can be provided as a network service program at the server computer side, for example. This program can be provided by being stored into various kinds of recording mediums such as an optical recording disk.

When a problem occurs in the resources of the server computer and the server computer cannot provide the network service, the information to be notified from the server computer to the client computer is transmitted to the user via the OS or the application program of the client computer. In other words, according to the present invention, information provided from the server computer can be properly transmitted to each user via the OS or the application corresponding to the level of each user such as a general user or a manager.

The present invention can be widely applied to a client server system that includes a server computer which is connected to a network and provides a network service and a client computer that uses the resources of the server computer via the network service. The invention can be also applied to a server computer clustered for redundancy.

As described in detail above, according to the present invention, there is provided a client server system in which a server computer can quickly transmit necessary information to a client computer when a problem occurs in the resources of the server computer.

Many different embodiments of the present invention may be constructed without departing from the scope of the present invention, and it should be understood that the present invention is not limited to the specific embodiments described in this specification, except as defined in the appended claims.

What is claimed is:

1. A client server system comprising:
a network;
a server computer that is connected to the network and provides a network service; and
a client computer that uses resources of the server computer via the network service, wherein:
the server computer manages identification information of the client computer that uses the sources provided by the network service, a type of a program that operates in the client computer using the resources, and a type of a user of the program of the client computer; and
when the network service cannot be provided due to an occurrence of a predetermined problem in the resources of the server computer, the server computer notifies the client computer about information of the network service based on the resources provided by the network service.

2. The client server system as claimed in claim 1, wherein:
the server computer notifies the client computer about whether the resources provided by the network service can be normally used at present, and when the resources cannot be normally used, the server computer notifies the client computer about a cause of the inability of using the resources, an estimate time taken until when the resources can be used normally, and a state that the network service cannot be provided.

3. The client server system as claimed in claim 2, wherein:
when the server computer receives a request for a permission of using the network service from the client computer while the network service cannot be provided, the server computer replies to the client computer that the network service cannot be used in response to the request from the client computer.

4. The client server system as claimed in claim 2, wherein:
the server computer has a clustered configuration; and
when one of nodes of the server computer cannot provide a network service, another node of the server computer that takes over the network service notifies the client computer that the network service cannot be used.

5. The client server system as claimed in claim 2, wherein:
the server computer has one or a plurality of the resources, and provides one or a plurality of the client computers with the network service.

6. The client server system as claimed in claim 2, wherein:
users of the client computer are classified into managers who have a special right of managing the installment of a program and starting and stopping the client computer, and general users who have a right of using only a special program.

7. The client server system as claimed in claim 2, wherein:
programs that operate within the client computer which uses the network service of the server computer are classified into a program that a general user of the client computer can directly start and stop, and a program that only a manager can start and stop and that provides the network service to the program that the general user uses.

8. A method of managing a client server system in which a server computer is connected to a network and provides a network service, and a client computer uses resources of the server computer via the network service, wherein:
the server computer manages identification information of the client computer that uses the resources provided by the network service, a type of a program that operates in the client computer using the resources, and a type of a user of the program of the client computer; and
when the network service cannot be provided due to an occurrence of a predetermined problem in the resources of the server computer, the server computer notifies the client computer about information of the network service based on the resources provided by the network service.

9. A management program of a client server system in which a server computer is connected to a network and provides a network service, and a client computer uses resources of the server computer via the network service, wherein:
the management program makes the server computer manage identification information of the client computer that uses the resources provided by the network service, a type of a program that operates in the client computer using the resources, and a type of a user of the program of the client computer; and
when the network service cannot be provided due to an occurrence of a predetermined problem in the resources of the server computer, the management program makes the server computer notify the client computer about information of the network service based on the resources provided by the network service.
